(19) United States
(12) Patent Application Publication
(10) Pub. No.: US 2009/0073251 A1
(43) Pub. Date: Mar. 19, 2009

(54) FULL-COLOR DIRECT LASER LABELING ARRANGEMENTS AND METHODS

(75) Inventor: Arthur R. Wheeler, Raleigh, NC (US)

Correspondence Address: FERENCE & ASSOCIATES LLC, 409 BROAD STREET, PITTSBURGH, PA, 15143, US

(73) Assignee: Lenovo (Singapore) Pte. Ltd. Singapore

(21) Appl. No.: 11/854,691

(22) Filed: Sep. 13, 2007

(51) Int. Cl. B41J 2/435

(52) U.S. Cl. 347/232

(57) ABSTRACT

A full-color direct disc labeling method that solves the monochromatic limitation associated with current direct disc labeling techniques. The techniques disclosed herein provide a unique, cost-effective method of implementing full-color direct disc labeling in the emerging class of blue laser optical drive recorders, known by trade names such as Blu-ray and HD DVD.

### FIELD OF THE INVENTION

The present invention relates generally to optical discs and methods and arrangements for labeling the same.

### BACKGROUND OF THE INVENTION

Direct disc labeling techniques have recently been introduced in optical disc drive (ODD) recorders, and this has provided an advanced capability to “burn” high quality monochromatic labeling information directly onto recordable optical discs using the drive recorder's existing data read/write laser optics system. Presently, two methods are generally employed to implement such direct disc labeling systems.

In a first method, an organic dye polymer coating is utilized on the label side of the disc. When the disc is then inserted into the drive recorder “upside down”, this enables the “burning” of selected portions of the disc by the drive's data recording laser to create contrasting elements in the dye, thus realizing text and art images that are visible to the naked eye. Hewlett-Packard employs this method in its “LIGHTSCRIBE” direct disc labeling technology.

In a second method, as employed in Yamaha's “LABELFLASH” direct disc labeling technology, a visible image is created by utilizing an organic dye data layer on the opposite side of double-sided recordable media. Instead of recording data on the opposite side, a label image is recorded. The end result is that the label image is actually beneath the surface of the media, whereas with the first method the image is on the surface of the media.

Both conventional implementations outlined above are limited in that the images created on the disc are monochromatic, since the effect of heating the label or data dye layer is to cause any existing colored dye to turn gray or black. So while the original color of the dye is selectable (albeit within limits), the contrasting areas created by the localized heating of the focused recording laser will be grayscale; thus the created image ends up being monochromatic.

U.S. Pat. No. 6,778,205, assigned to Hewlett-Packard, largely describes monochromatic processes of the type utilized in “LIGHTSCRIBE” products as discussed above. At the same time, any conceivable manner of effecting colored labels with such technology would likely be cumbersome, inefficient and lacking in versatility.

In view of the foregoing, a compelling need has been recognized in connection with providing a direct disc labeling technique that improves upon conventional efforts, especially by way of improving upon the monochromatic images brought about by such efforts.

### SUMMARY OF THE INVENTION

Broadly contemplated herein, in accordance with at least one presently preferred embodiment of the present invention, is a full-color direct disc labeling method that solves the monochromatic limitation associated with current direct disc labeling techniques. The techniques disclosed herein provide a unique, cost-effective method of implementing full-color direct disc labeling in the emerging class of blue laser optical drive recorders, known by trade names such as Blu-ray and HD DVD.

In summary, one aspect of the invention provides an apparatus comprising: a disk drive; the disk drive comprising a plurality of lasers, each laser acting to read and record data from and to a disc; a detection module which ascertains a position of a disc in the disk drive; each laser acting to alter an appearance of a portion of a disc in the disk drive; the lasers cooperating with the detection module to impart a predetermined pattern to a disc.

Another aspect of the invention provides a method comprising the steps of: inserting a disc into a disk drive; ascertaining a position of the disc within the disc drive; imparting a predetermined, position-based pattern to the disc; the imparting comprising: activating a first laser to alter an appearance of a first portion of the disc; and activating a second laser to alter an appearance of a second portion of the disc.

Furthermore, an additional aspect of the invention provides a program storage device readable by machine, tangibly embodying a program of instructions executable by the machine to perform a method comprising the steps of: inserting a disc into a disk drive; ascertaining a position of the disc within the disc drive; imparting a predetermined, position-based pattern to the disc; the imparting comprising: activating a first laser to alter an appearance of a first portion of the disc; and activating a second laser to alter an appearance of a second portion of the disc.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1A schematically illustrates a computer system.

FIG. 1 graphically illustrates dye sensitivities as a function of the wavelengths of different lasers.

FIG. 2 provides a cross-sectional view of a three-layer full-color direct label disc.

### DETAILED DESCRIPTION OF THE PREFERRED EMBODIMENTS

For a better understanding of the present invention, together with other and further features and advantages thereof, reference is made to the following description, taken in conjunction with the accompanying drawings, and the scope of the invention will be pointed out in the appended claims.

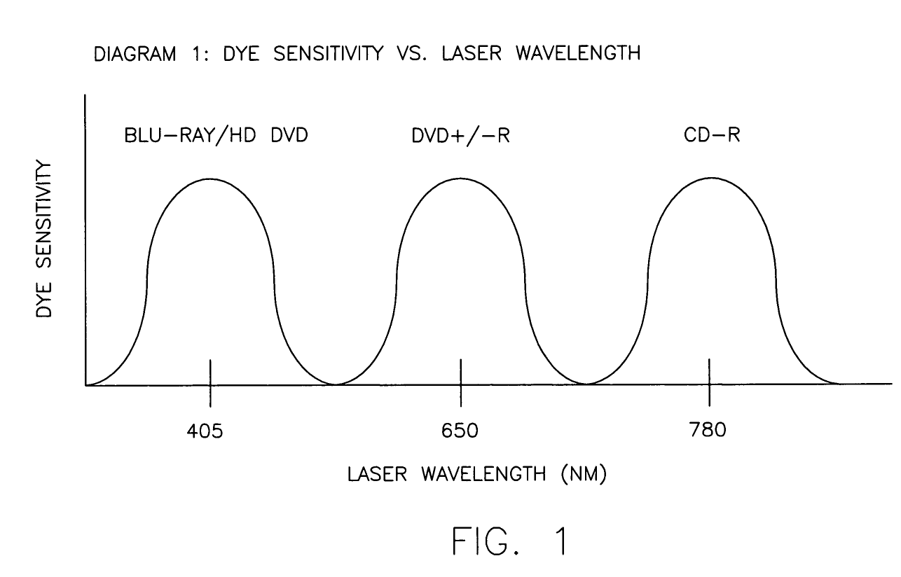

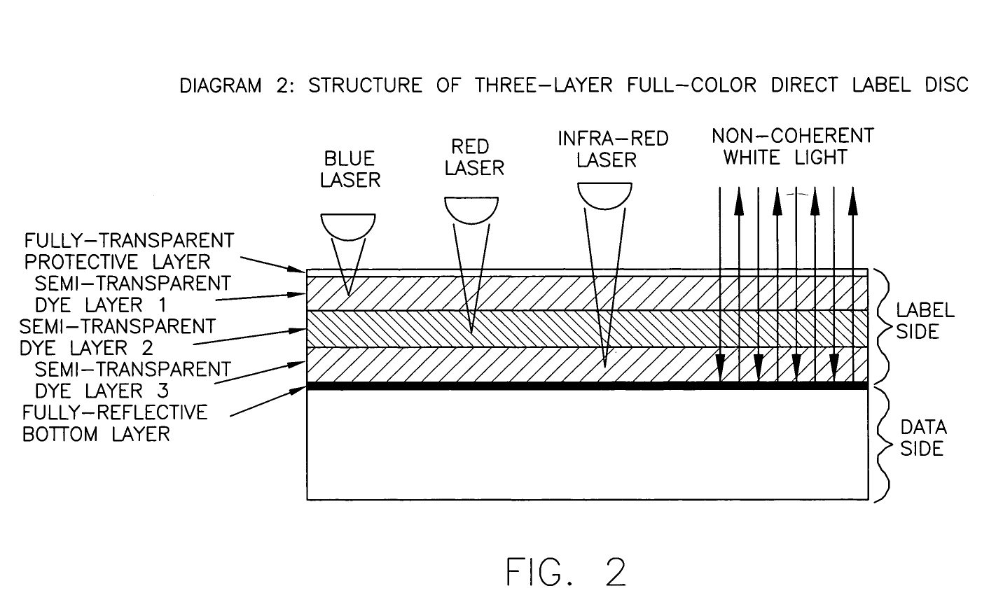

It will be readily understood that the components of the present invention, as generally described and illustrated in the Figures herein, may be arranged and designed in a wide variety of different configurations. Thus, the following more detailed description of the embodiments of the apparatus, system, and method of the present invention, as represented in FIGS. 1A through 2, is not intended to limit the scope of the invention, as claimed, but is merely representative of selected embodiments of the invention.

One or more functional units described in this specification may be labeled as a “module”, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals or other labels throughout. The following description is intended only by way of example, and simply illustrates certain selected embodiments of devices, systems, and processes that are consistent with the invention as claimed herein.

One possible implementation of at least one embodiment of the present invention is in the disk drive of a computer system, though of course other disk drives (e.g., stand-alone disc players and recorders) can serve as an environment for one or more embodiments of the present invention. Referring now to FIG. 1, there is depicted a block diagram of an illustrative embodiment of a computer system 12. The illustrative embodiment depicted in FIG. 1 may be a notebook computer system, such as one of the ThinkPad® series of personal computers sold by Lenovo (US) Inc. of Morrisville, N.C., however, as will become apparent from the following description, the present invention is applicable to any data processing system.

As shown in FIG. 1, computer system 12 includes at least one system processor 42, which is coupled to a Read-Only Memory (ROM) 40 and a system memory 46 by a processor bus 44. System processor 42, which may comprise one of the AMD™ line of processors produced by AMD Corporation or a processor produced by Intel Corporation, is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 12 to LAN 10, and graphics adapter 68, which interfaces computer system 12 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 12 further includes Industry Standard Architecture (ISA) bus 62, which is coupled to PCI local bus 50 by ISA bridge 64. Coupled to ISA bus 62 is an input/output (I/O) controller 70, which controls communication between computer system 12 and attached peripheral devices such as a keyboard, mouse, and disk drive 72. In addition, I/O controller 70 supports external communication by computer system 12 via serial and parallel ports. Of course, it should be appreciated that the system 12 may be built with different chip sets and a different bus structure, as well as with any other suitable substitute components, while providing comparable or analogous functions to those discussed above.

Disk drive 72 may preferably be configured to accommodate CD, DVD and Blu-ray discs as discussed herebelow not only for reading purposes but also for recording (“burning”) purposes. Disk 72 may preferably be functionally integrated with a disc position detection module 74 to be described more fully below. As discussed herebelow, a disk drive 72 may preferably include three lasers for reading and/or burning purposes, and these may be employed for imparting a colored label to a disc in manners now to be described.

Generally, optical disc drive recorders utilizing 405 nm wavelength blue-violet lasers have been developed to achieve much higher recording densities compared to the predecessor 650 nm red laser DVD and 780 nm infrared laser CD recorders. However, for full backward compatibility with existing CD and DVD media, integrated optical pickup (OPU) units utilizing three laser optics systems (405, 650, and 780 nm) are now being implemented on most commercially available drives.

Another technology recently developed is that of semi-transparent organic dye polymers that are used for two-layer DVD+/-R recording. These polymers allow unfocused laser light to pass through a top layer to enable a focused spot on the underlying second layer for data recording and playback.

Accordingly, in accordance with at least one presently preferred embodiment of the present invention, the aforementioned triple-wavelength integrated optical systems and semi-transparent organic dye layers may be employed to create full-color human-readable labels directly on recordable discs.

As part and parcel of a process according to at least one embodiment of the present invention, organic dyes currently used in one-time recordable CD (CD-R), DVD (DVD-R and DVD+R), and Blu-ray/HD DVD (BD-R/HD DVD-R) discs are wavelength sensitive; i.e., they are “tuned” to react to a narrow wavelength band surrounding the recording laser wavelength. To illustrate this phenomenon, FIG. 1 graphically illustrates dye sensitivities as a function of the wavelengths of the three lasers in question.

Furthermore, semi-transparent versions of these dyes can be made that allow unfocussed laser light to pass through them; these are currently utilized in DVD, HD DVD, and Blu-ray multi-layer recordable media. Preferably, such properties are utilized in accordance with at least one presently preferred embodiment of the present invention to create full-color visible images on specially-prepared recordable media, and as can be seen in FIG. 2 (a cross-sectional view of a three-layer full-color direct label disc). Preferably, one side of the medium, the “data” side 0, contains the traditional CD, DVD, or Blu-ray/HD DVD data recording layer(s). The opposite side of the medium, however (“label” side 0′) preferably contains three layers of semi-transparent organic dye (1, 2, 3), with each layer corresponding to one of three primary colors red, green, blue, or their complements magenta, yellow, cyan (before burning). These three layers are sandwiched between a fully-transparent top protective layer 4, and a fully reflective bottom layer 5.

Accordingly, each of the three dye layers 1/2/3 is preferably sensitive to one of the three laser wavelengths (405, 650, or 780 nm), and will darken when focused light of sufficient power in the sensitive range is applied. By modulating the three drive lasers (blue 5, red 6 and infra-red 7) as they pass over the label side 0′ of the disc (either serially or in parallel, depending on the OPU design), areas of each primary color can be selectively neutralized (darkened or “burned”) to create a full-color image from the three primary color layers on the disc, analogous to the way wavelength-sensitive silver halides are selectively darkened in three-layer photographic film emulsions to create full-color images. Non-coherent white light (8) will of course pass through all three layers 1/2/3 and be reflected back from bottom layer 5.

In brief recapitulation, it should be appreciated and understood, with reference to FIG. 2, that preferably there may be three stacked layers of dye 1/2/3 provided on a “label” side 0′ of a disc, and each of the three layers 1/2/3 is preferably responsive to a different one of the three lasers 5/6/7 of a disc drive. Since shorter wavelengths translate to shorter focus depths, the layer 1 responsive to blue laser 5 is preferably provided on top, followed by the layer 2 responsive to red laser 6, followed by a layer 3 responsive to infrared laser 7. Since the dyes in layers 1/2/3 are configured to be sensitive solely to specific wavelengths (or wavelength ranges), then a given laser 5/6/7 will not be fully focused when passing through one or more specific layers other than the “target” layer for that laser. For instance, the infra-red laser 7 will not be in full focus when passing through dye layers 1 and 2, since these layers are not sensitive (and thus not responsive to) the characteristic infrared laser wavelength(s).

In an alternative implementation in accordance with the present invention, dyes may preferably be provided for layers 1, 2 and 3 that turn clear when exposed to given laser lights (rather than going opaque as in the case outlined just above).

An alternative implementation is also conceivable, wherein a single-layer emulsion of three primary color dyes is applied to the label side, with each dye component reacting to its respective laser wavelength sensitivity to create full-color images in a single layer using the three wavelengths available in the drive OPU. Using these techniques, cost-effective full-color direct disc labeling can be achieved to improve upon conventional monochromatic arrangements. Though a wide variety of implementations are possible, a favorable implementation could preferably involve the combination of the three colors into a single emulsion, whereby primary color component would react only to its specific wavelength sensitivity.

In order to implement one or more embodiments as broadly contemplated herein in accordance with the present invention, a disk drive 72 (see FIG. 1) may preferably include a capability (74) for detecting the position of a disc inserted into the drive. This “disc position detection” module 74 can be implemented as new or modified software incorporated into (or in functional connection with) drive 72, or via a suitable sensor, or both. As such, a disc may include some type of encoding on its inner radius to “mark” a specific “home” or “zero” rotational position of the disc, while module 74 can preferably be configured to detect or ascertain the position of this “home” or “zero” at any time. Alternatively, a disc may include one or more “wobble grooves” distinct from the “spiral” grooves that normally contain data. This “wobble groove” could be embodied by a closed groove (i.e., it describes an arc about the disc's center of rotation of no more than 360 degrees) that defines a varying radius with respect to the disc's center of rotation. If the varying radius is in the form of, e.g., a sine wave, then preferably module 74 may be configured to count sine wave excursions so as to ascertain the rotational position of a disc. In any of these cases, ascertaining the rotational position of a disc will assist in imparting a desired, predetermined pattern or “label” to “label” side 0′ of a disc, e.g., by selectively activating and deactivating one or more of the lasers 5/6/7 at different times and in different positions (with respect to the disc) as the disc rotates.

It is to be understood that the present invention, in accordance with at least one presently preferred embodiment, includes elements that may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An apparatus comprising:
a disk drive;
said disk drive comprising a plurality of lasers, each said laser acting to read and record data from and to a disc;
a detection module which ascertains a position of a disc in said disk drive;
each said laser acting to alter an appearance of a portion of a disc in said disk drive;
said lasers cooperating with said detection module to impart a predetermined pattern to a disc.

2. The apparatus according to claim 1, wherein said plurality of lasers comprises three lasers.

3. The apparatus according to claim 2, wherein said three lasers comprise a blue-violet laser, a red laser and an infrared laser.

4. The apparatus according to claim 2, wherein said disk drive acts to accommodate DVD's, CD's and Blu-ray discs.

5. The apparatus according to claim 2, wherein said disk drive acts to accommodate a disc with multiple dye layers.

6. The apparatus according to claim 5, wherein said disk drive acts to accommodate a disc with multiple dye layers, wherein an appearance of each dye is altered responsive to a predetermined laser wavelength.

7. The apparatus according to claim 5, wherein said disk drive acts to accommodate a disc with multiple dye layers, wherein each dye layer maintains an original appearance responsive to a laser wavelength other than a predetermined laser wavelength.

8. The apparatus according to claim 2, wherein said disk drive acts to accommodate a disc with multiple semi-transparent dye polymer layers, each layer corresponding to a different primary color.

9. The apparatus according to claim 2, wherein said disk drive acts to accommodate a disc with a single emulsion layer comprising multiple dye regions, wherein an appearance of each dye region is altered responsive to a predetermined laser wavelength.

10. The apparatus according to claim 1, wherein said detection module acts to ascertain a rotational position of a disc in said disk drive.

11. A method comprising the steps of:
inserting a disc into a disk drive;
ascertaining a position of the disc within the disc drive;
imparting a predetermined, position-based pattern to the disc;
said imparting comprising:
activating a first laser to alter an appearance of a first portion of the disc; and
activating a second laser to alter an appearance of a second portion of the disc.

12. The method according to claim 11, further comprising the step of activating a third laser to alter an appearance of a third portion of the disc, wherein said plurality of lasers comprises three lasers.

13. The method according to claim 12, wherein the first, second and third lasers respectively comprise a blue-violet laser, a red laser and an infrared laser.

14. The method according to claim 12, wherein the disc comprises a plurality of dye layers.

15. The method according to claim 14, wherein said steps of activating a first laser, a second laser and a third laser respectively prompt each dye layer to alter its appearance responsive to a predetermined laser wavelength.

16. The method according to claim 14, wherein said steps of activating a first laser, a second laser and a third laser respectively prompt each dye layer to maintain an original appearance responsive to a laser wavelength other than a predetermined laser wavelength.

17. The method according to claim 12, wherein the disc comprises a plurality of semi-transparent dye polymer layers, each layer corresponding to a different primary color.

18. The method according to claim 12, wherein:
the disc comprises a single emulsion layer comprising a plurality of dye regions;
said steps of activating a first laser, a second laser and a third laser respectively prompt each dye region to alter its appearance responsive to a predetermined laser wavelength.

19. The method according to claim 11, wherein said ascertaining step comprises ascertaining a rotational position of a disc in said disk drive.

20. A program storage device readable by machine, tangibly embodying a program of instructions executable by the machine to perform a method comprising the steps of:
inserting a disc into a disk drive;
ascertaining a position of the disc within the disc drive;
imparting a predetermined, position-based pattern to the disc;
said imparting comprising:
activating a first laser to alter an appearance of a first portion of the disc; and
activating a second laser to alter an appearance of a second portion of the disc. and
activating a third laser to alter an appearance of a third portion of the disc.
